(19) United States
(12) Patent Application Publication
(10) Pub. No.: US 2025/0360523 A1
(43) Pub. Date: Nov. 27, 2025

(54) ELECTROSTATIC COATING MACHINE

(71) Applicant: Carlisle Fluid Technologies, LLC, Scottsdale, AZ (US)

(72) Inventors: Tatsuya Nakaishi, Yokohama (JP); Shokichi Ishibashi, Yokohama (JP)

(21) Appl. No.: 18/851,861

(22) PCT Filed: Apr. 27, 2023
(86) PCT No.: PCT/US2023/020184

§ 371 Date: Sep. 27, 2024

Related U.S. Application Data
(60) Provisional application No. 63/335,730, filed on Apr. 28, 2022.

(30) Foreign Application Priority Data
May 23, 2022 (JP) 2022-714156

(51) Int. Cl. B05B 5/10

(52) U.S. Cl. CPC B05B 5/10

(57) ABSTRACT

An electrostatic coating machine according to the present embodiments can reduce the risk of sparking even when setting a higher line speed than before when performing coating according to a proximity painting method. In the coating machine that performs electrostatic coating by use of a high voltage generated by a cascade, when a time constant τ is defined as the product of a total capacitance Co of the electrostatic coating machine and a bleeder resistor R1, the product of the total capacitance Co and the bleeder resistor R1 is set so that the time constant τ is 0.005 to 0.050.

### CROSS REFERENCE TO RELATED APPLICATIONS

This application is a national stage application under § 371 of PCT/US2023/020184, filed 27 Apr. 2023, which claims the benefit of provisional application 63/335,730, filed 28 Apr. 2022 and Japan Patent Application 2022-714156, filed 23 May 2022, which are both incorporated as if fully rewritten herein.

### TECHNICAL FIELD OF THE INVENTION

The present embodiments can relate to an electrostatic coating machine. More specifically, the present embodiments can relate to the electrostatic coating machine suitable for use in a proximity coating method. Conventionally, coating distance, i.e., the distance between an electrostatic coating machine and an object to be coated (hereinafter referred to as “workpiece”), is generally set about 150 mm to 300 mm. The proximity coating method is to operate the electrostatic coating machine at the distance closer than 150 mm. The conventional coating method in which the distance between the workpiece and the electrostatic coating machine, i.e., the coating distance, is set about 150 mm to 300 mm is called a “distal coating method”, while the coating method that operates at the coating distance shorter than 150 mm is called the “proximity coating method”. According to the present embodiments, the risk of ignitable discharges (hereinafter referred to as “spark”) that is problematic in the proximity coating method can be reduced. The term “spark” means a spark discharge having a discharge energy (0.24 mJ) or more in which the solvent vapor ignites.

### BACKGROUND OF THE INVENTION

Electrostatic coating machines perform coating by using high voltage. The electrostatic coating machine charges a paint by high voltage applied. The charged paint is electrostatically adsorbed on the workpiece. Therefore, the electrostatic coating machine includes a high voltage application path for applying high voltage generated by a high voltage generator to the tip of the coating machine (e.g., a rotating atomizing head or external electrodes). The coating machine including the electrostatic coating machine has a high voltage controller for controlling the electrostatic coating machine. In order to ensure safety during operation, high voltage control functions are incorporated into the high voltage controller to control high voltage applied to the electrostatic coating machine. In addition, the high voltage controller is constantly fed with high voltage current flowing through the high voltage application path to perform high voltage safety control.

There are various methods for generating high voltage, such as Cockcroft-Walton circuit (multistage rectifier circuit), AC voltage rectifier type, electrostatic generator, and impulse type, etc. The Cockcroft-Walton circuit (multistage rectifier circuit) is a circuit that generates high voltage by charging a number of capacitors to generate high voltage. The high voltage generator of Cockcroft-Walton circuit has been miniaturized and is known as a “cascade”. The cascade is now commonly incorporated into the electrostatic coating machine. An electrostatic coating machine with a built-in cascade is called a “pack-in type electrostatic coating machine”. An electrostatic coating machine that receives a high voltage supply from an external high voltage generator through a high voltage cable (HV cable) is referred to as a “pack-out type electrostatic coating machine”. In contrast to the “pack-out type electrostatic coating machine,” the pack-in type electrostatic coating machine has an advantage of not requiring the HV cable.

There are three solutions that have been implemented in the distant coating method to address the issue of spark during coating operation. The first is an overcurrent safety control function, the second is a high output voltage control function, and the third is a minimum high voltage protection control function. Patent document 1 discloses these three functions.

The overcurrent safety control function includes a first function for abnormal detection of high voltage current based on absolute sensitivity (current limit (CL) control), and a second function for detecting abnormal increases in the high voltage current for a certain period of time based on differential sensitivity (slope sensitivity (SLP)). When an abnormality is detected, the power supply to the cascade is cut off and an output of the high voltage generator is stopped.

The output high voltage control function, in current buffer control, reduces the absolute value of the high voltage output of the high voltage generator without stopping the output of the high voltage generator when the high voltage current reaches a current limit (CB). That is, the output high voltage control function reduces the absolute value of the high voltage output of the high voltage generator so that the high voltage current does not exceed the current limit value.

The minimum high voltage protection control function operates by reducing the output voltage of the high voltage generator through the operation of the output high voltage control function, and when the absolute value falls below a high voltage lower limit sensitivity (UV) in an undervoltage control, it performs an output stop operation of the high voltage generator.
[Patent Document 1] JP Patent Publication H02 (1990)-298374A

### SUMMARY OF THE INVENTION

In the conventional distal coating method, when the electrostatic coating machine approaches abnormally close to the workpiece and as a result, the high voltage current rises abnormally, the aforementioned overcurrent safety control function detects this and immediately works. Based on the operation of the overcurrent safety control function, the cascade stops its output.

In order to increase the coating efficiency, it is better to bring the electrostatic coating machine closer to the workpiece. From this viewpoint, the proximity coating method (JP Patent Publication 2017-13009A) has been considered.

The proximal coating method is to set the coating distance short. If the spark generation prevention measures implemented in the distal coating method described above are applied directly to the proximal coating method, the spark generation prevention measures may not be able to keep up with the close coating distance. As a result, the adoption of the proximal coating method leads to an increase in the risk of spark generation.

In recent years, there has been a trend to increase the coating speed (hereinafter referred to as “line speed”) of a coating machine in order to improve production efficiency. The electrostatic coating machine has long been adopted for automobile coating for a long time. In automotive coating, the conventional line speed was 300 mm/sec to 500 mm/sec, there is a trend to increase the line speed to 500 mm/sec to 1200 mm/sec.

Coating robots are widely used not only for automotive coating but also for general coating of various products (“general coating”). In the general coating, the proximity coating method and faster line speed have begun to be considered for higher efficiency. Not only applying the spark generation prevention measures used in the aforementioned distant coating method to the proximity coating method but also when increasing the line speed, the spark generation prevention measures cannot be followed more and more, and as a result, it goes without saying that the risk of spark generation increases more and more.

An objective of the present embodiments can be to provide an electrostatic coating method that can reduce the risk of spark generation even if the line speed is set faster than conventional when performing coating according to the proximity coating method.

The present embodiments can be understood by focusing on the relationship between a line speed and a time constant τ of an electrostatic coating machine in order to quickly attenuate the residual charge in the high voltage supply system of the electrostatic coating machine to a safe level after the high voltage safety function is activated in order to reduce sparks caused by residual voltage in the coating machine. The present embodiments can be charactered in that the product of the total capacitance C₀ of the electrostatic coating machine and the bleeder resistor R₁ that attenuates the residual voltage is set so that the time constant τ is 0.005 to 0.050. The bleeder resistor can be a single resistor, or multiple resistors arranged in series, parallel, or combinations thereof to achieve the desired time constant.

In the present embodiments, the time constant τ of 0.015 to 0.033 can be preferred.

Here, the time constant τ is defined by the following equation 1.

$$τ = {C}_{0} \times {R}_{1} \qquad ( Equation 1 )$$

Here, as explained later, C₀ is a total capacitance and R₁ is a bleeder resistor.

In general terms, “time constant” means the relaxation time in an electric circuit and is defined as the time it takes to reach 63.2% of equilibrium.

### BRIEF DESCRIPTION OF DRAWINGS

FIG. 1 is a general overview of the electrostatic coating machine to which the present embodiments can be applied.

FIG. 2 illustrates the ideal high voltage control that prevents an electrostatic coating machine from generating a spark.

FIG. 3 shows the overall configuration of the high voltage safety control section of the electrostatic coating machine.

FIG. 4 illustrates the decay of residual voltage in a conventional electrostatic coating machine to avoid sparking when approaching a workpiece at a line speed of 300 mm/sec.

FIG. 5 illustrates the decay of residual voltage in a conventional electrostatic coating machine to avoid sparking when approaching a workpiece at a line speed of 500 mm/sec.

FIG. 6 illustrates that sparking cannot be avoided by the conventional method when the approach to the work piece is at a line speed of 1200 mm/sec. in a conventional electrostatic coating machine.

FIG. 7 is a list to illustrate the relationship among line speeds, braking distances and braking times.

FIG. 8 illustrates the effect of designing the electrostatic coating machine to have a time constant according to the embodiments at a line speed of 1200 mm/sec.

FIG. 9 illustrates the relationship between high voltage values and workpiece currents on the high voltage operation ideal line at each coating distance.

FIG. 10 shows the relationship between coating distances and workpiece currents for each line speed when-60 kV is applied.

FIG. 11 shows the relationship between coating distances and workpiece currents for each line speed when-30 kV is applied.

FIG. 12 is a diagram for explaining change characteristics of the set values of CB and CL when control is executed to change the set values of CB and CL.

### DETAILED DESCRIPTION OF THE PRESENT INVENTION

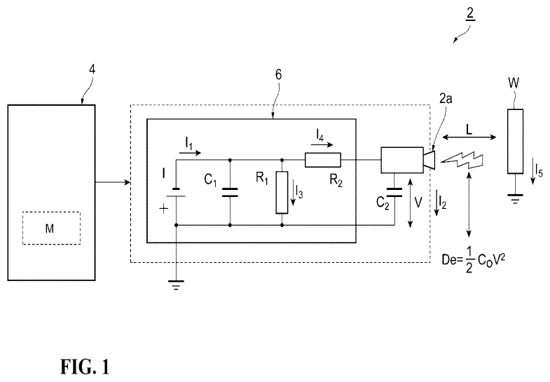

FIG. 1 shows the overall configuration of an electrostatic coating machine to which the present embodiments can be applied. Reference numeral 2 indicates the electrostatic coating machine, and reference numeral 4 denotes a high voltage controller. The reference numerals in FIG. 1 represent the following elements.
R₁: Bleeder resistor
R₂: Series resistors
V: High voltage at the tip of the coating machine
I₁: Total current (high voltage generator current)
I₂: Leakage current
I₃: Bleeder resistor current (I₃=V/R₁)
I₄: Output current (I₄=I₁−I₃)
I₅: Workpiece current (I₅=I₁−I₂−I₃)
C₁: Capacitance of Cascade 6
C₂: Capacitance from the cascade 6 to the tip of the electrostatic coating machine 2, excluding the cascade 6
C₀: Total capacitance
De: Discharge energy
L: Coating distance (distance between a coating machine and a workpiece)
W: Workpiece

The electrostatic coating machine 2 shown in FIG. 1 is a rotary atomizing type coating machine equipped with a rotary atomizing head 2a, but the present embodiments are not necessarily limited to a rotary atomizing type coating machine and can also be applied to an air atomizing type electrostatic coating machines or a hydraulic atomization type electrostatic coating machine.

Referring to FIG. 1, the discharge energy De when a spark occurs due to the energy possessed by the entire electrostatic coating machine 2, including the cascade 6 that generates high voltage, can be expressed by the following Equation 2.

$$De = ( 1 / 2 ) \times {C}_{0} \times {V}^{2} \qquad ( Equation 2 )$$

Here, the overall capacitance of the electrostatic coating machine 2, i.e., the total capacitance C₀ can be defined by the following Equation 3.

$${C}_{0} = {C}_{1} + {C}_{2} \qquad ( Equation 3 )$$

As is well known, the cascade 6 composed of a Cockcroft-Walton circuit (multistage rectifier circuit) charges AC high voltage to capacitors from the internal transformer side and stacks it while rectifying with diodes to generate negative DC high voltage. Here, the boosted negative high voltage is prevented by the diodes from returning to the internal transformer side. The high voltage current flows from the output terminal inside the cascade 6 to the workpiece W and a bleeder resistor R₁. Therefore, only the bleeder resistor R₁ substantially removes the charged capacitance or residual charge of the capacitors of cascade 6. Based on this analysis, the time required to discharge the residual charge, i.e., the time constant τ, can be defined by the Equation 1 above (τ=C₀×R₁). The capacitance, C₀, can be a single capacitor, capacitors in series, capacitors in parallel, or combinations thereof.

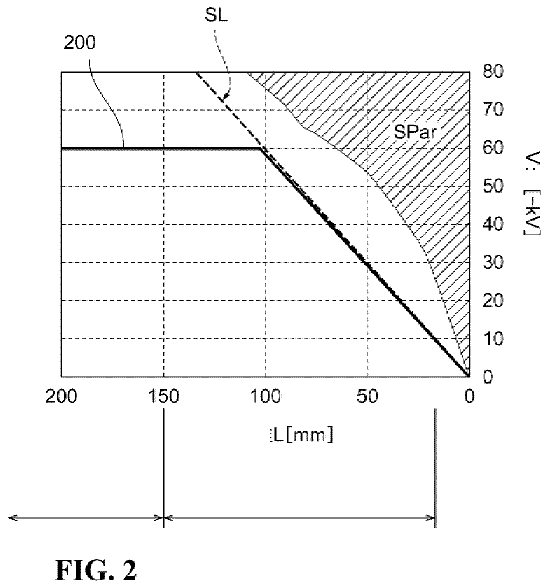

In the aforementioned electrostatic coating machine 2 described with reference to FIG. 1, FIG. 2 illustrates a Spark Generation Area SPar based on experimental results. A dashed line SL indicates a safety line that serves as a high voltage safety guide to prevent a spark from occurring during a coating process. The safety line SL shows that the occurrence of a spark can be prevented by lowering the absolute value of the high voltage V by about 6 kV when the electrostatic coating machine 2 approaches the workpiece W by 10 mm, if the coating distance L is explained in units of 10 mm.

With the safety line SL in mind, the solid line 200 in FIG. 2 illustrates an ideal safe high voltage control in the proximity coating method when the electrostatic coating machine 2 to which a negative high voltage of −60 kV is applied approaches the workpiece W from L=200 mm (the safety distance in the conventional distal coating method). When the electrostatic coating machine 2 approaches the workpiece W further from the coating distance L=100 mm, the high voltage is controlled along the safety line SL. When the electrostatic coating machine 2 approaches the workpiece W by 10 mm, the occurrence of a spark can be prevented by executing a control that lowers the absolute value of the high voltage V by about 6 kV.

Now, in the operation of coating by a coating robot, a large workpiece, such as an automobile body, is coated while placed on a carriage. The workpiece on the carriage undergoes only a small positional displacement due to being placed on the carriage during the coating process. This allows the coating machine to execute the coating process while maintaining the desired relative position with respect to the workpiece under the control of the coating robot.

Relatively small workpieces, such as door mirror covers, are hung on hangers and suspended from an overhead trolley-type conveyor. That is, the conveyor is placed on the ceiling, and the hangers hanging the workpieces are transported by the conveyor. Electrostatic coating is then performed by using a coating robot. The workpieces are placed on the hangers and the hangers are then suspended from the conveyor by a worker. It is not easy to accurately place the workpieces on the hangers. In addition, the hangers suspended from the conveyor swing during transportation by the conveyor. Therefore, the position of the coating machine relative to the workpieces is not constant. In order to adopt the proximity coating method under such a situation, it is necessary to develop a method that reduces the risk of spark occurrence. That is, it is necessary to develop a method that ensures a high level of safety under an appropriate operation of the proximity coating method.

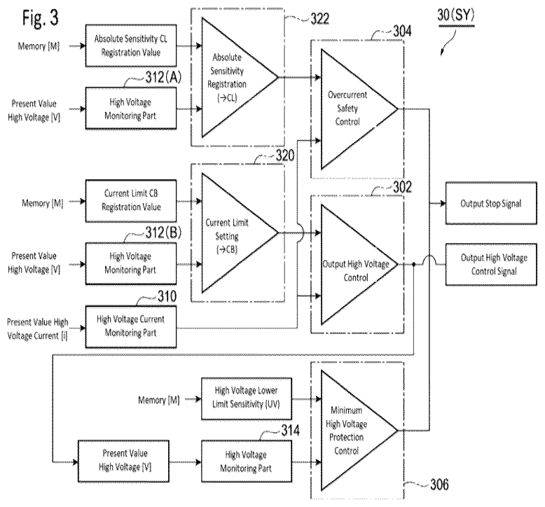

The high voltage controller 4 has a memory M (FIG. 1), and the high voltage controller 4 incorporates circuits that execute an overcurrent safety control function, an output high voltage control function, and a minimum high voltage protection control function, as shown in FIG. 3.

The high voltage safety control section 30 includes a high voltage current value monitoring section 310 that constantly monitors the current high voltage output current 14, and high voltage monitoring sections 312(A), 312(B) that constantly monitor the current high voltage V. The high voltage current value monitoring section 310 captures the high voltage current that is not affected by the pulsating component AV due to the Cockcroft-Walton circuit.

The current value of the output current I₄ of the high voltage is supplied from the high voltage current value monitoring section 310 to the output high voltage control section 302 and the overcurrent safety control section 304. The output high voltage control section 302 generates an output high voltage control signal that reduces the value of the output high voltage V of cascade 6 when the rising high voltage output current I₄ reaches the current limit value CB. Based on this output voltage control signal, the output of cascade 6 is controlled (execution of output high voltage control function (CB)).

As in the past, the overcurrent safety control section 304 generates an output stop signal when the high voltage output current I₄ rises abnormally to a value higher than the absolute value sensitivity CL. Based on this output stop signal, the output of cascade 6 is stopped (execution of the overcurrent safety control function (CL)).

In FIG. 3, the reference numeral 320 indicates a CB setting change section, and the reference numeral 322 indicates a CL setting change section. Although the CB setting change section 320 and CL setting change section 322 are not necessarily essential components, the CB setting change section 320 and CL setting change section 322 are preferred to be provided to reliably prevent the occurrence of a spark. The current value of high voltage V is input from the high voltage monitoring sections 312(A) and 312(B). In the CB setting change unit 320, the registered value of the current limit value CB read from the memory M is input to the CB setting change section 320, and the set value of the current limiting value CB is changed so as to correspond to the current value based on the current value of the high voltage V. In the CL setting change section 322, the registered value of absolute sensitivity CL read from memory M is input, and the set value of the absolute sensitivity CL is changed so as to correspond to the current value based on the current value of the high voltage V.

The output high voltage control section 302 executes the output high voltage control (CB) based on the set value of current limit CB received from the CB setting change section 320. The overcurrent safety control section 304 executes the overcurrent safety control (CL) based on the set value of absolute sensitivity CL received from the CL setting change section 322.

The value of the high voltage V generated by the output high voltage control section 302 is supplied to the minimum high voltage protection control section 306 through the high voltage monitoring section 314 as being the current high voltage value. The minimum high voltage protection control section 306 receives a registered value of the high voltage lower limit sensitivity UV read from the memory M. The minimum high voltage protection control section 306 performs the minimum high voltage protection control based on the set value of the high voltage lower limit sensitivity UV. That is, when the absolute value of the output voltage of the cascade 6 becomes less than or equal to the high voltage lower limit sensitivity UV, the output of the cascade 6 is stopped.

While performing electrostatic coating by operating the coating robot (not shown in Figs), if the electrostatic coating machine 2 abnormally approaches the workpiece W, causing an abnormal increase in the output current I₄ [output current (I₄=I₁−I₃)], the overcurrent safety control function immediately begins to work when this is detected. Based on the start of the overcurrent safety control function (hereinafter referred to as CL control and SPL control), the output of the cascade 6 is stopped. In addition, for the output high voltage control by the output high voltage control function (CB control), it is necessary to rapidly reduce the absolute value of the high voltage V at the tip of the electrostatic coating machine corresponding to the line speed.

SLP control is widely known, and the high voltage current value is read at regular time intervals (sampling time), and the registered value of the differential sensitivity SLP read from the memory M is added to set it as a threshold. As mentioned above, it works as a safety control function when the output current I₄ of the high voltage rises abnormally. Note that it is necessary to prepare the safety control function in duplicate or triplicate for safe operation of electrostatic coating. By the way, the optimum sampling time for higher line speed in proximity coating is 10-100 msec.

In the proximity coating method, there is a new issue that differs from the conventional distant coating method when the output of Cascade 6 is stopped due to abnormal proximity or when the absolute value of the output high voltage is reduced by CB control. This new issue is the charge remaining on the electrostatic coating machine. The following will explain this issue.

The CL control and SLP control begin to work in response to an emergency stop signal based on the detection of abnormal rise in high voltage current. After the high voltage controller 4 shuts off the power supply to the cascade 6, an electric charge remains in the electrostatic coating machine 2. The amount of residual charge depends on the size of the total capacitance C₀ of the high voltage application path including the cascade 6 (example, a high voltage electrode such as the rotating atomizing head 2a or an air motor). If the total capacitance C₀ is large, the amount of residual charge increases, and it takes time for the residual voltage to decay.

Next, it takes time for the coating robot to completely stop moving from the generation of the emergency stop signal. This time is called the “braking time”. In addition, the movement of the painting robot continues from the generation of the emergency stop signal until the inertial motion of the painting robot is completely stopped. The amount of movement of the coating machine due to this continued inertial motion is called the “braking distance.

In the proximity coating method, coating is executed with the coating machine close to the workpiece. Therefore, even if an abnormality is detected and an emergency stop signal is generated, and control to stop the movement of the coating robot is executed based on this emergency stop signal, the movement of the coating robot does not stop immediately, and the braking time and the braking distance problems described above always occur. That is, during the braking time, the coating robot moves, and the coating machine moves together with the coating robot. In proximity coating, depending on the braking distance, the electrostatic coating machine 2 constituting a part of the painting robot may invade the spark generation area SPar. As a result, there is a risk of spark generation due to the residual voltage.

CB control lowers the absolute value of the high voltage output by the high voltage generator when the high voltage current reaches the current limit value (CB), without stopping the output of the high voltage generator. At this time, even if the high voltage controller 4 executes the control to lower the absolute value of the high voltage at this time, the high voltage cannot be dropped faster than the time that the residual voltage of the electrostatic coating machine 2 can be attenuated.

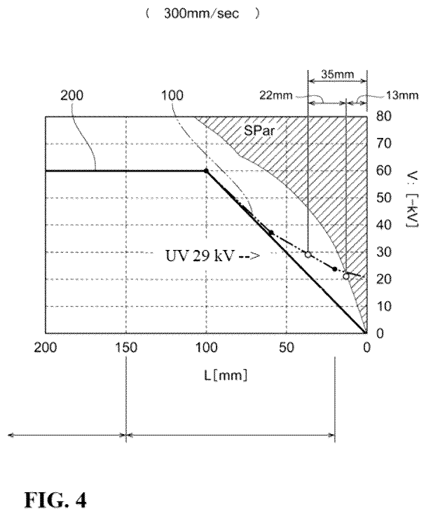

FIG. 4 is a diagram related to a conventional electrostatic coating machine, and is a diagram showing the decay of residual voltage corresponding to the high voltage operation ideal line of FIG. 2, that is, the high voltage safety ideal line 200. The time constant τ of the conventional electrostatic coating machine was calculated to be τ=0.132. FIG. 4 is a diagram when the worst-case situation is assumed to approach the workpiece at a line speed of 300 mm/sec. The double-dotted line 100 in FIG. 4 is a residual voltage decay curve when the output high voltage of the cascade 6 is stopped or the amount of drop control of CB control is maximized, and the tip voltage V drops to 63.2% every 0.132 sec., starting from the point where the coating distance L=100 mm and the tip voltage V=−60 kV of the electrostatic coating machine.

Referring to the dashed line 100 in FIG. 4, when the electrostatic coating machine is at a line speed of 300 mm/sec., the electrostatic coating machine travels 100 mm at 0.33 sec. The distance to enter the spark generation area SPar is about 13 mm. Calculating backwards from the braking distance of about 22 mm at the line speed of 300 mm/sec and if an emergency stop signal is sent to the coating robot by about 35 mm before the spark generation area SPar, the occurrence of a spark can be avoided. Since the dashed line 100 approximates the high voltage operation ideal line (solid line), CB control is also possible by using the output high voltage control function.

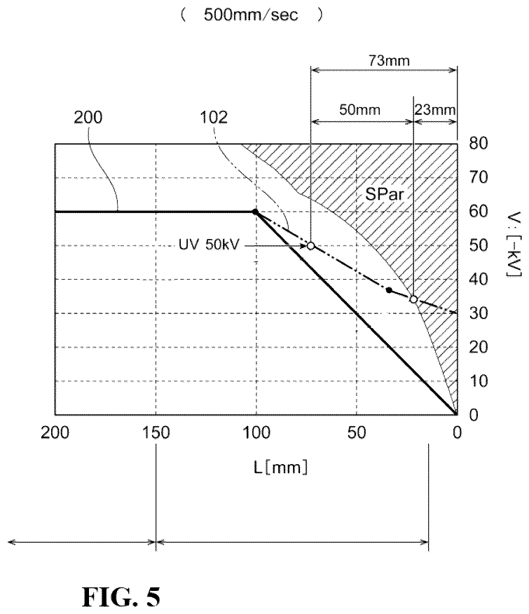

FIG. 5 is a diagram when it is assumed that the coating machine approaches the workpiece at a speed of 500 mm/sec. Referring to the two-dotted line 102 in FIG. 5, in the case of the line speed is 500 mm/sec, the coating machine travels 100 mm in 0.20 sec. The distance to enter the spark generation area SPar is about 23 mm. Calculating backwards from the braking distance of about 50 mm at the line speed of 500 mm/sec and if an emergency stop signal is sent to the coating robot by about 73 mm before the spark generation area SPar, the occurrence of a spark can be avoided.

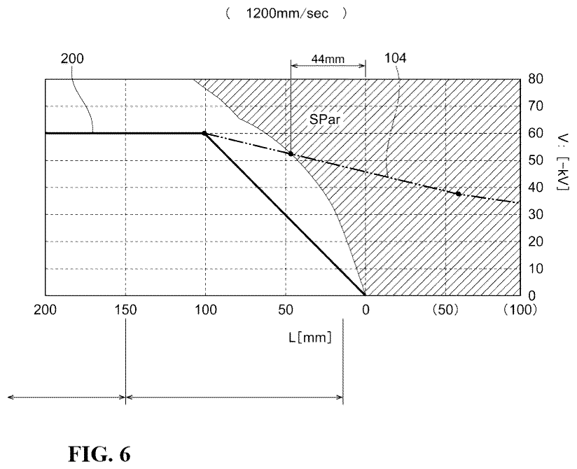

FIG. 6 shows the situation when operating at a line speed of 1200 mm/sec. Referring to the two-dotted line 104 in FIG. 6, in the case of the line speed is 1200 mm/sec, the coating machine travels 100 mm at 0.083 sec. The distance to enter the spark generation area SPar is about 44 mm. Thus, the braking distance of 1200 mm/sec is 280 mm. It is necessary to send an emergency stop signal to the coating robot by about 324 mm before the spark generation area Spar. This means that the proximity coating method itself cannot be established. Even if CB control is performed by using the output high voltage control function, CB control is also impossible because it does not approximate the high voltage operation ideal line 200, i.e., the high voltage safety ideal line.

That is, even if the high voltage controller 4 controls aiming at the high voltage operation ideal line 200, the residual voltage V of the entire electrostatic coating machine 2 is much higher than the high voltage operation ideal line 200. Thus, CB control cannot follow the high voltage operation ideal line 200.

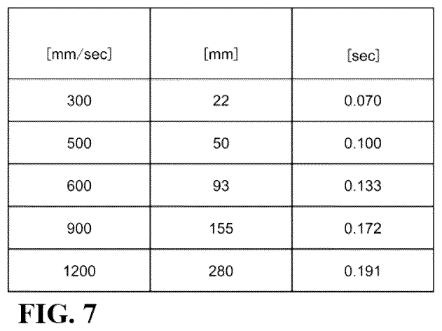

FIG. 7 shows the relationship (actual measured values) between the line speed, the braking distance, and the braking time of a typical coating robot.

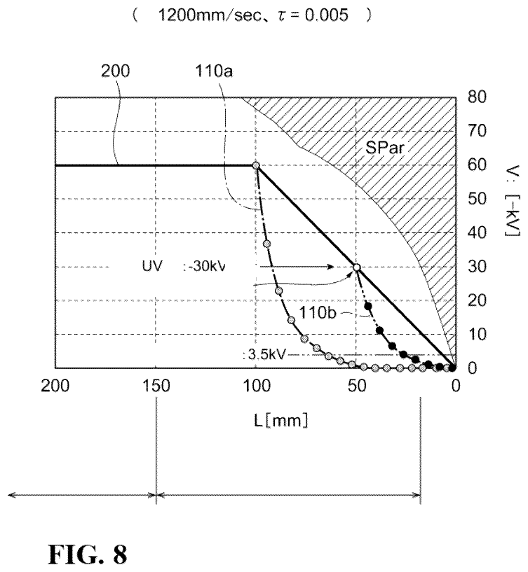

In order to achieve a line speed of 1200 mm/sec in the proximity coating method, it is necessary to attenuate the residual voltage at high speed. A specific example that can realize this is shown in FIG. 8. Referring to FIG. 8, decent curves at the time constant τ=0.005, which is less than the high voltage operation ideal line at a line speed of 1200 mm/sec, are shown by one-dotted line 110a and two-dotted line 110b in FIG. 8. Here, the one-dotted line 110a shows the case of the fastest attenuation from the painting distance L=100 mm at −60 kV. In the coating distance L=100 mm to 50 mm, the high voltage V at the tip of the coating machine is lower than the high voltage operation ideal line 200, so the operation is performed according to the high voltage operation ideal line 200 with CB control and the high voltage drops to −30 kV at the coating distance L=50 mm. When UV is detected at the point where the coating distance L=50 mm and drops to −30 kV, the output high voltage is stopped. The two-dotted line 110b shows attenuation from −30 kV and coating distance L=50 mm. As described above, even if the coating machine approaches at a line speed of 1200 mm/sec., the residual voltage drops below a safe voltage, so it can be seen that the coating machine does not enter the area SPar. The safe voltage means a voltage at which De does not reach the ignition energy (0.24 mJ) from the discharge energy (Equation 2). The safe voltage is determined by the product of the high voltage V at the tip of the electrostatic sprayer and the total capacitance Cₒ. Specifically, −3.5 kV is exemplified as a guideline for the safe voltage.

When the time constant τ=0.005 is smaller, the size of the cascade 6 becomes larger due to the power characteristics of the bleeder resistor R₁ and the boosting characteristics of the Cockcroft-Walton circuit, and the cascade 6 cannot be installed in the electrostatic coating machine 2, the cascade 6 may be arranged externally. As a modification, a semi-conductive film known from JP Patent Laid-Open Publication H08(1996)-187453 or a resistor having a function equivalent to the function of the bleeder resistor R₁ may be provided on the outer periphery or inside between the high voltage body and the ground point of the electrostatic coating machine

When the time constant τ=0.005, an example of the total capacitance C₀, the bleeder resistor R₁ is C₀=10 pF, R₁=500 MΩ. Here, the optimal area of time constant τ in the specific example is 0.015 to 0.033.

As mentioned above, in the proximity coating method where the coating distance L is 150 mm or less, control in units of at least 10 mm is required. When the line speed is 1200 mm/sec, the travel time of 10 mm is 8.3 msec. Therefore, the high voltage controller 4 in FIG. 1 reads the output high voltage and high voltage current fed back from the cascade 6 with a sampling time of 0.1-2 msec. at a higher speed, and processes it at high speed to perform high voltage operation aimed at the high voltage operation ideal line 200.

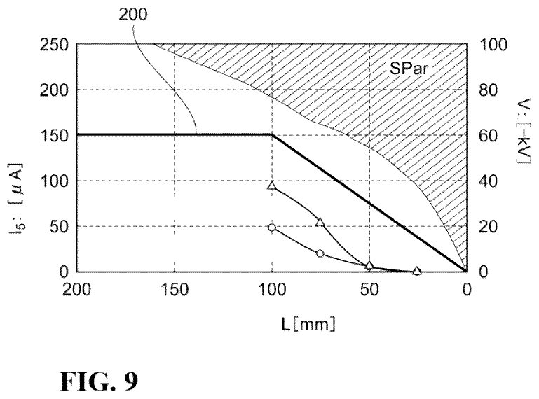

FIG. 9 is a diagram in which the following relationship is added to illustrate the above-described relationship between the coating distance L and the high voltage. That is, in FIG. 9, the coating current I₅ at a high voltage value V on the high voltage operation ideal line 200 at each coating distance L=100 mm or less is added. The mark “Δ” indicates the current value for a plate-shaped workpiece W. The mark “∘” indicates the current value for a spherical workpiece W. High safety can be maintained by performing CB control for the workpiece current I₅ according to the current output high voltage based on the spherical workpiece W in which the high voltage current does not easily flow. Furthermore, the difference in the workpiece current due to the difference in the shape of the workpiece from about −30 kV around the coating distance L=50 mm becomes small. That is, at around −30 kV or less, only the relationship between the output high voltage value and the high voltage current value makes it possible to read this as the coating distance L. At the same time, up to the coating distance L=50 mm, excessive high voltage current to the edge-shaped workpiece can be suppressed.

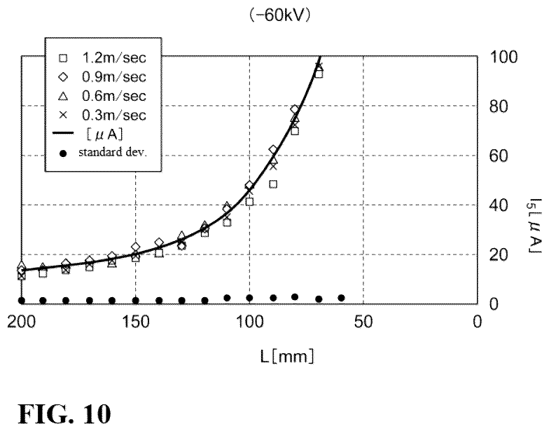

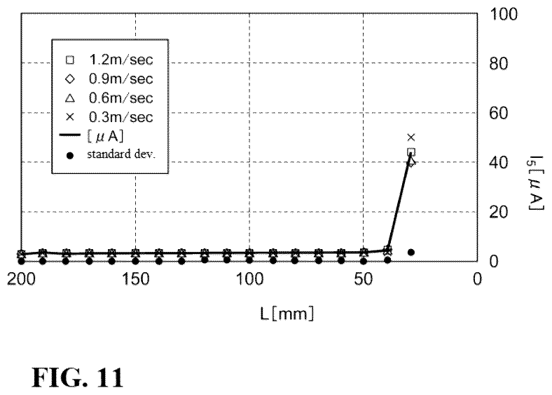

FIG. 10 shows the relationship between the coating distance L and the coating current I₅ at −60 kV of the high voltage of the tip of the coating machine, while FIG. 11 shows the same relationship at −30 kV, with different line speeds of 300 mm/sec (mark: x), 600 mm/sec (mark: Δ), 900 mm/sec (mark: ⋄), and 1200 mm/sec (mark: □). The solid lines indicate the mean values, and the dot marks (●) indicate the standard deviations at each coating distance L. These show that the standard deviation is less than 5, regardless of the line speed, indicating that the relationship between the coating distance L and the workpiece current I₅ is consistent. This confirms that the coating distance L can be inferred from the relationship between the high voltage V of the tip of the electrostatic coating machine and the workpiece current I₅.

Considering the portable mass of the coating robot wrist and the braking distance of the coating robot wrist, the electrostatic coating machine, which is located at the very tip of the wrist, is preferably lightweight. The volume of the cascade 6 built into the coating machine is limited to about 180 cm³ (36 mm×180 mm). Here, attention is focused on the nominal power of the bleeder resistor R₁ and its volume. For example, when 60 kV is applied to 100 MΩ, 600 μA always flows to the bleeder resistor. Since the power consumption at this time is 36 W, a large resistor for high power is required to reduce heat generation. The volume of the bleeder resistor R is about 780 cm³ (46 mm×470 mm). Therefore, it is very difficult to pack-in the cascade inside the coating machine. If the bleeder resistor R₁ is 500 MΩ, the power consumption will be as low as 7.2 W. Therefore, a typical resistor can be used. The volume is about 9 cm³ (φ8.5 mm×162 mm). If this is the case, the bleeder resistor R₁ can be packed in.

In the case of an ultra-close coating method where the coating distance L=100 mm or less, in order to ensure a high level of safety in which the output high voltage V is accurately and quickly dropped according to the coating distance L, it is preferable to use a mechanism for detecting the leakage of the high voltage disclosed in JP Patent No. 4678858. In the mechanism, for the coating current I₅ obtained by subtracting the bleeder resistance current I₃ and the leakage current I₂ from the total current I₁, a control that changes the CB control value according to the current output high voltage V of the tip of the coating machine is preferably performed.

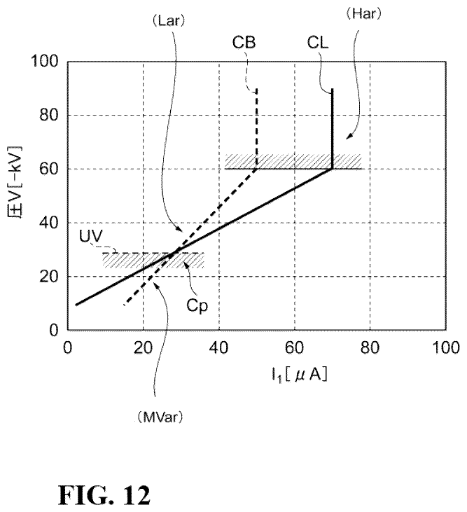

FIG. 12 is a diagram for explaining changes in CB set values in relation to the CB setting changer 320 having a function of changing the set value of the current limit value (CB) mentioned above and the CL setting changer 322 (see FIG. 3) having a function of changing the set value of the absolute value sensitivity (CL). Referring to FIG. 12, the high voltage change area (voltage drop due to output high voltage control (CB)) in the operation of the proximity coating method is 60 kV or less of the output voltage V in this embodiment. The region above the change area of the output voltage V is called a “relative high voltage area Har”. On the other hand, the region in which the absolute value of the output voltage V is lower than the relative high voltage area Har is called a “relative low voltage area Lar”. The relative low voltage area Lar corresponds to a coating distance L of 20 mm-200 mm. The Minimum high voltage protection area (MV) indicates an area where UV is blocked.

In the relative high voltage area Har, the current limit value (CB) is a constant value (CB is about 50 μA) with respect to the output voltage V. On the other hand, in the relative low voltage area Lar, the set value of the current limit value (CB) is changed. Specifically, in the relative low voltage area Lar, when the absolute value of the output voltage V is smaller than when it is large, the set value of the current limit value (CB) is changed to a small value. Preferably, in the relative low voltage area Lar, the set value of the current limit value (CB) is set to a smaller value (about 30 μA or more and about 50 μA or less) as the absolute value of the output voltage V decreases. More preferably, in the relative low voltage area Lar, the set value of the current limit value (CB) is gradually changed to a smaller value as the absolute value of the output voltage V decreases, as can be seen from FIG. 12. The setting of the current limit value (CB) is changed by the CB setting change unit 320 (FIG. 3). Preferably, each value of the output voltage V and the corresponding set value of the current limit value (CB) are registered in memory M.

During operation, the CB setting change section 320 reads the registered value of the current limit (CB) corresponding to the current value of the high voltage V from the memory M and supplies the set value of the current limit (CB) based on this read registered value of the current limit (CB) to the output high voltage limit control section 302 (FIG. 3). The output high voltage control performed in the output high voltage limit control section 302 is executed based on the set value of the current limit value (CB) received from the CB setting change section 320.

By changing the set value of the current limit (CB), the set value of the current limit (CB) changes sensitively in response to a decrease in the absolute value of the high voltage V at the tip of the coating machine. Then, based on this changing current limit value (CB), the absolute value of the high voltage V at the tip of the machine is lowered (output high voltage control function). This causes a sharp drop in the high voltage V at the tip of the coating machine 2. In addition, the high voltage total current I₁ also rapidly becomes a small value.

By setting the product of the total electrostatic capacitance C₀ and the bleeder resistor R₁ of the electrostatic coating machine 2 to achieve a time constant τ is between 0.005 and 0.050, and by adding a control to change the setting of the current limit (CB) described above, the risk of spark generation can be reliably reduced.

Similarly, the CL setting change section 322 can also be set such that the sensitivity value (CL) is preferably set to a smaller value as the absolute value of the high voltage V at the tip of the coating machine decreases, as shown in FIG. 12.

In the relatively low-voltage area Lar, when the absolute value of the high voltage V is large compared to that of the low voltage V, the set value of the absolute value sensitivity (CL) is set to a smaller value when the absolute value of the high voltage V is small. Preferably, in the relative low voltage area Lar, the set value of the absolute value sensitivity (CL) is changed to a smaller value as the absolute value of the high voltage V becomes lower. Even more preferably, as can be seen in FIG. 12, in the relative low voltage area Lar, the set value of the absolute sensitivity (CL) is gradually changed to a smaller value as the absolute value of the high voltage V becomes lower. Then, when contrasted at the same high voltage, the absolute value sensitivity (CL) is set to a value greater than the current limit (CB) (CB<CL). Preferably, the smaller the absolute value of the high voltage V, the larger the difference between the absolute value sensitivity (CL) and the current limit value (CB) should be set.

For example, when a spark is about to occur due to a breakdown or accident, that is, when the output high voltage control (CB) cannot follow up in time, the overcurrent safety control works based on the absolute sensitivity (CL) set to a small value as the absolute value of the high voltage V decreases, and the output of Cascade 6 is interrupted. This overcurrent safety control can back up safety performance functions.

In some embodiments, an electrostatic coating machine that performs electrostatic coating by use of high voltage generated by a cascade, characterized in that when a time constant τ is defined as the product of a total capacitance Co of the electrostatic coating machine and a bleeder resistor R1, the product of the total capacitance Co and the bleeder resistor R1 is set so that the time constant τ is 0.005 to 0.050. In certain embodiments, the product of the total capacitance Co and the bleeder resistor R1 is set so that the time constant τ is 0.015 to 0.033. In certain embodiments, the electrostatic coating machine has a high voltage safety control section that controls the high voltage applied to the electrostatic coating machine, the high voltage safety control section performs control to drop an absolute value of a high voltage output by a high voltage generator without stopping an output of the high voltage generator when a high voltage current reaches a current limit. In certain embodiments, the high voltage safety control section further includes a CB setting change section that changes a set value of the current limit based on a current value of the high voltage, in the CB setting changing section, in a relative low voltage area where the absolute value of the high voltage is lower than a predetermined threshold value, the current limit is set to a smaller value when the absolute value of the high voltage is smaller when comparing when the absolute value of the high voltage is large and when it is small. In certain embodiments, the electrostatic coating machine has a high voltage safety control section that controls the high voltage applied to the electrostatic coating machine. The output high voltage control section reduces an absolute value of a high voltage output by a high voltage generator without stopping the output of the high voltage generator when a high voltage current reaches a current limit. In certain embodiments, the high voltage safety control section further includes a CB setting change section that changes a set value of the current limit based on a current value of the high voltage, in the CB setting changing section, in a relative low voltage area where the absolute value of the high voltage is lower than a predetermined threshold value, the current limit is set to a smaller value when the absolute value of the high voltage is smaller when comparing when the absolute value of the high voltage is large and when it is small. In certain embodiments, the electrostatic coating machine incorporates a cascade. In certain embodiments, the electrostatic coating machine is a rotary atomization type electrostatic coating machine having a rotating atomizing head.

### EXPLANATION OF REFERENCE NUMERALS

2: Electrostatic Coating Machine
4: High voltage controller
6: Cascade
R₁: Bleeder resistor
W: Workpiece
L: Coating distance (separation distance between a coating machine and a workpiece)
C₀: Capacitance of an entire electrostatic coating machine (total capacitance)
I₁: Total current
30: High voltage safety control section
320: CB setting change section

We claim:

1. An electrostatic coating machine configured to perform electrostatic coating by charging the coating with a voltage generated by a cascade and directing the coating toward a grounded workpiece, wherein the cascade comprises
a resistance to ground;
a capacitance to ground, wherein the resistance to ground and capacitance to ground are in parallel; and
a time constant, wherein the time constant is an arithmetic product of the resistance to ground in ohms and capacitance to ground in farads, wherein the time constant is between 0.005 seconds and 0.050 seconds.

2. The electrostatic coating machine of claim 1, wherein the time constant is between 0.015 seconds and 0.033 seconds.

3. The electrostatic coating machine of claim 2, wherein the time constant is between 0.018 seconds and 0.030 seconds.

4. The electrostatic coating machine of claim 1, wherein the resistance to ground comprises a bleeder resistor in parallel with a direct current power supply, wherein the bleeder resistor comprises a first bleeder resistor connection between a terminal of the direct current power supply and a second bleeder resistor connection to ground.

5. The electrostatic coating machine of claim 4, wherein the bleeder resistor comprises a resistance of 1000 megaohms to 2000 megaohms.

6. The electrostatic coating machine of claim 4, wherein the capacitance to ground consists of a first capacitance and a second capacitance, wherein the first capacitance comprises primary first capacitance connection between a terminal of the direct current power supply and a secondary first capacitance connection to ground.

7. The electrostatic coating machine of claim 6, wherein the capacitance to ground is between 20 and 40 picofarads, and the value of the first capacitance is the capacitance to ground minus a second capacitance.

8. The electrostatic coating machine of claim 7, wherein the second capacitance comprises a primary second capacitance connection between a series resistor and an applicator and a secondary second capacitance connection to ground.

9. The electrostatic coating machine of claim 8, wherein the second capacitance is in parallel with the bleeder resistor and the first capacitance.

10. The electrostatic coating machine of claim 1, further comprising an output voltage control unit configured to reduce the absolute value of the voltage generated by the cascade without stopping the output of the high voltage generator when the output current reaches a current limit value.

11. The electrostatic coating machine of claim 10, wherein the current limit value is a dynamic value based on the voltage generated by the cascade.

12. The electrostatic coating machine of claim 11, wherein the current limit value increases as the absolute value of the voltage increases within a first voltage domain.

13. The electrostatic coating machine of claim 12, wherein the current limit value is static as the absolute value of the voltage increases within a second voltage domain, wherein the second voltage domain is higher than the first voltage domain.

14. The electrostatic coating machine of claim 13, wherein the output voltage control unit is configured to stop voltage generation by the cascade when the output current reaches an absolute sensitivity value, wherein the absolute sensitivity value is a dynamic value based on the voltage generated by the cascade.

15. The electrostatic coating machine of claim 14, wherein the absolute sensitivity value increases as the absolute value of the voltage increases within the first voltage domain, and wherein the absolute sensitivity value is static as the absolute value of the voltage increases within the second voltage domain.
